(19) United States
(12) Patent Application Publication
(10) Pub. No.: US 2009/0087820 A1
(43) Pub. Date: Apr. 2, 2009

(54) EDUCATIONAL LEARNING SYSTEM AND METHOD

(76) Inventor: Steve Chandless, San Mateo, CA (US)

Correspondence Address: GREGORY SMITH & ASSOCIATES, 3900 NEWPARK MALL ROAD, 3RD FLOOR, NEWARK, CA, 94560, US

(21) Appl. No.: 12/240,803

(22) Filed: Sep. 29, 2008

Related U.S. Application Data
(60) Provisional application No. 60/997,120, filed on Sep. 29, 2007.

(51) Int. Cl. G09B 19/22; A63F 1/00

(52) U.S. Cl. 434/129; 273/299

(57) ABSTRACT

The present invention shows a learning system including game components and a method of using the game components that constitute an educational game. The game components have a container which has a plurality of compartments plus a plurality of individual flash cards that display educational content on one or both faces of the individual flash cards. The method of use can be a single-user or multi-user both of which enables learning and mastering information. The method of use provides learners with systematic repetitive learning methods that ensure multiple exposures to flash cards containing educational content which have not yet be mastered by a learner. The method of use also precisely tracks and organizes the progress made by learners and systematically directs the learner's efforts towards individual flash cards that have not yet been mastered and away from individual flash cards that have already been mastered. The multi-user method of use encourages a competitive educational game. The learning system allows learners to reap the benefits of a personalized and customized learning experience without the need for direct teacher involvement.

### CROSS REFERENCE TO OTHER APPLICATIONS

The present application claims the benefit of the priority date of provisional patent application Ser. No. 60/997,120, filed Sep. 29, 2007, for an EDUCATIONAL LEARNING SYSTEM COMPRISED OF DEVICE AND METHOD OF USE, by Steven G. Chandless, included by reference herein and for which benefit of the priority date is hereby claimed.

### FIELD OF THE INVENTION

The present invention relates to an educational learning system and, more particularly, to a learning system that is usable as a game playable by one or more players.

### BACKGROUND OF THE INVENTION

Educational professionals have long sought effective tools for teaching to a wide range of student competency levels within a class. Today's classroom environment challenges teachers to teach to a wide range of student competencies and often with fewer resources. Previously, teachers have relied on teaching tools such as flash cards, supplemental exercises and educational games like word or math bingo. Many of these tools now available to teachers are of little help in their quest to teach to the specific needs of individual students because these tools cannot be easily customized, personalized or adapted to the different needs of each student.

Committing new concepts and information to memory can be tedious for students and especially difficult for struggling learners. Over the years, teachers and parents have employed tools they hoped would make repetition and memorization learning more engaging. Examples of these tools are: flash cards, word and math Bingo games, supplemental homework exercises, and other methods such as multi-sensory learning exercises. Each of these tools has its drawbacks for both students and teachers.

Students may quickly tire or become bored with the rote techniques of repetition dependent learning such as traditional flash card exercises. Additionally, students may become easily uninterested with the level of difficulty of word and math bingo games when they are played at a competency level that is below or above their skill levels. Alternatively, struggling students such as dyslexics and ESL (English as a second language) students may become frustrated by learning with educational games that are too advanced for their skills. Finally, students who are bored and frustrated at school are less motivated and therefore less likely to take advantage of supplemental learning exercises, especially if they are to be done outside of school.

Traditional educational games and tools also have drawbacks for teachers. Teachers have large classes with students that have a wide range of abilities in reading, writing and math. Teaching effectively in this type of classroom requires breaking students out into small groups and providing targeted individual instruction. Teachers are increasingly aware of the shortcomings of traditional educational games like bingo that require the teacher to lead the game, thus preventing the teacher from roaming the classroom to provide individual instruction where needed. Bingo also does not allow the teacher to match each individual student's skill level to the level of learning material in a game of bingo. This is a significant problem when too many players with a wide range of skills are playing at the same time. Games usually are selected to target the learning needs of the “average” student in the group, which means that a significant percentage of students, statistically speaking 20% to 50%, may be learning material that is not well matched to their learning needs, skill level or capabilities.

Traditional flash cards and flash card exercises suffer from the same drawbacks as some of the well known educational games in the art. An inability to match each individual student's skill level to the level of learning material is one such inadequacy. Flash card kits usually lump all flash cards into a single group and are not divided into clearly marked smaller groups of flash cards separated by skill level. Consequently, an additional shortcoming of flash cards from a teacher's perspective, is the inconvenience and prohibitive time and cost required to create smaller bundles or groups of flash cards that are differentiated by skill level, theme or some other characteristic matching a student's needs. Today's teachers often do not have the time or resources, such as assistant teachers, to create these specialized flash card groups themselves.

Using existing games in the classroom as a learning tool has other drawbacks such as taking a minimum amount of time to play, which may not correspond to the amount of time available in the classroom. This results in uncompleted games causing less engagement from students and reduced teaching effectiveness because the material to be learned is not fully reviewed before the game must be put away. Another drawback can include the teaching of too broad a range of concepts and information, sometimes combining material from several grade levels. Teachers who want to correctly match a student's competency level with an appropriate level of material must carefully sort and filter the multi-grade level breadth of material included in some games. This manual filtering may need to be done repeatedly which is an ineffective use of the teacher's time. Furthermore, educational games, especially non-electronic ones, are often designed in a way that randomly exposes the student to the full range of learning material incorporated into the game. This randomness of material exposure creates two problems. First, it is burdensome to track what material each student has been exposed to, how many exposures have occurred and consequently their degree of mastery of that material. Even after repeated use, a student may not have been exposed to all of the learning material included in the game. Secondly, this randomness makes learners spend time reviewing material they already know at the expense of other material not mastered. The result is a much less efficient learning tool than one that is able to direct a learner's efforts towards material not yet mastered.

Numerous educational games and learning tools have been provided in the prior art and while these inventions may be suitable for the particular purpose to which they address, they would not be suitable for the purposes addressed in the present invention. One such game is useful in learning the specific words preprinted on a game board, however, there is no ability to incorporate new words or other learning material into the game without purchasing an entirely new game board. Additionally, some games only move game pieces instead of flashcards, thereby not allowing the player the chance to read every piece of learning material in the game. This reduces the learning opportunity because not all materials are covered during the game. Furthermore, given the structure of some game methods, a player would repeat each educational item only a few times, which does not provide for mastery of the material. Also, most game methods do not have a way to filter out materials that have already been mastered, thus forcing the player to focus on materials already learned. Another example of current art is an electronic game that teaches phonetic pronunciation of words and letters but is not designed to systematically differentiate between already mastered material and not yet mastered material. Not lastly, other art cannot be customized to the needs of each individual player or are not competitive in nature thereby unlikely to hold the interest of players. What is needed is an educational learning system that uses independent content personalization to easily customize, personalize and adapt its educational content to the different skill levels of each student. Removing or reducing exposure to already mastered material and making memorization learning more engaging is another desirable outcome of the invention. Furthermore, a game with the ability to be paused without disturbing the order of game components or the progress of game play is an objective of the invention. Not lastly, an increase in teacher-student individual instruction is also an objective of the invention.

### SUMMARY OF THE INVENTION

In accordance with the present invention, there is provided a learning system including game components and a method of using the game components that constitute an educational game. The game system has a container having several compartments that hold a plurality of individual flash cards with educational content printed thereon. The game components have a means for adding chance to the game such as a die, spinner, electronic number generator, etc. and a means for tracking the advancement of individual flashcards such as but not limited to the game container or game board. The game system may be compact and portable with a low cost of ownership. Additionally, the game system may be inexpensive to manufacture, with durable parts that are easily replaced if lost or damaged and individual or a bundle of individual flash cards that may be incrementally added as the skill level or needs of the students grow and change. The individual flash cards are color-coded to denote the competency level of the cards and to allow students and teachers to easily identify appropriate learning material and progress along a known spectrum of difficulty. The color-coded individual flash cards facilitate learning for multiple users at different skills levels by allowing independent content personalization for each player in a game. The color-coded individual flash cards also promote competitiveness between players of different knowledge levels by permitting independent content personalization resulting in every player having an equal chance to win the game. The flash cards may use a plurality of educational content including but not limited to words, letters, numbers, equations, languages and machine readable code. The educational game can be paused and restarted without losing track of progress achieved.

The game system can be played by one or more players. Each player uses the game to learn, improve, or master concepts and information by selecting and answering a plurality of individual flash cards. The objective of the educational game is to move as many correctly answered flash cards to the highest number on the game board or container. A correct answer yields advancement of the flash cards to a higher numbered position on the game board or alternatively in the numbered transport container. In one preferred embodiment, a game board has a plurality of numbered spaces aligned linearly and are consecutively numbered. Each player preferably has his own game board within which he places all of the selected flash cards in the lowest numbered space on the game board at the start of the game. A flash card may then be advanced after each time the flash card has been responded to correctly.

With the single-user method of use, a flash card may be typically advanced only one space each time the flash card is answered correctly. This is a very effective learning method because of the number of repetitions required to successfully move the flash card to the highest numbered space on the game board. Embedded repetition guarantees multiple exposures to not yet mastered concepts during game and study sessions. With the multi-player method of use, game play is competitive and results in a winner after a number of rounds of play. Interactive die play within every turn of multi-player mode of the game adds to the competitive nature thereby maintaining interest in the subject matter. Each player's flash cards are advanced based on a combination of skill and chance since die or some other tool such as a numbered spinner are used to determine the number of flash cards answered each turn and the number of spaces the flash cards can be moved after a correct answer is given.

Some of the benefits of the invention may include providing a learning system that uses independent content personalization. This allows learning content and competency levels to be uniquely chosen and used by any player engaged in a game to meet his specific learning needs and goals independent of the learning content and competency levels chosen by any other player in the game. Thus players of different skill levels can play against each other without unduly favoring the player with greater skill in the subject matter. The players may also use different educational content from each other. Flash cards may come categorized, organized and grouped by level of difficulty, by theme or by academic competency. This makes the game easily customized, scalable, personalized and adapted to the needs of individual students. The invention would allow students to increase the difficulty of material by purchasing individual or a bundle of flash cards. Also, the teacher would have the ability to freely roam the classroom providing attention to individual students as needed.

Fluency filtering may be achieved during course of games and study sessions by removing or reducing the exposure to already mastered material either by removing or advancing more quickly the mastered flash cards. This would provide a learning system that systematically tracks and sorts educational materials not yet mastered differently from educational material already mastered, thereby improving the learning effectiveness of the educational game. Systematic reordering of flash cards may be incorporated during the game process so that a student cannot easily rely on the previous order thereby increasing actual mastery of the educational material. Still further objects and advantages will become apparent from a consideration of the following description and the accompanying drawings.

### BRIEF DESCRIPTION OF THE DRAWINGS

A complete understanding of the present invention may be obtained by reference to the accompanying drawings, when considered in conjunction with the subsequent, detailed description, in which:

FIG. 1A is a front perspective view of an embodiment of a container used with this invention.

FIG. 1B is a front view of an embodiment of a plurality of sight word flash cards used with this invention.

FIG. 1C is a front view and back view of an embodiment of a single flash card.

FIG. 1D is a representation of an embodiment of a single-user method of use.

FIG. 1E is a representation of an embodiment of a multi-user method of use.

FIG. 2 is a side perspective view of an alternative embodiment of a container with six compartments and a locking lid.

FIGS. 3A and 3B show top views of an alternative embodiment of FIG. 1A showing the container with a detached lid.

FIGS. 3C and 3D show side views of the embodiment of FIGS. 3A and 3B.

FIG. 4 is a front perspective view of an alternative embodiment of FIG. 1A showing the container with an attached lid with offset lid dividers.

FIG. 5 is a top view of an alternative embodiment of a container showing a two-rowed container with linearly aligned compartments.

FIG. 6A is a front and back view of one example of a sight word flash card used with this invention, with a sight word printed on the front face of the flash card and a corresponding machine readable code printed on the back face of the flash card.

FIG. 6B is a front and back view of one example of a language translation flash card used with this invention, with an English word printed on the front face of the flash card and a corresponding Spanish word and word variations printed on the back face of the flash card.

FIG. 6C is a front and back view of one example of a math equation flash card used with this invention, with an equation printed on the front face of the flash card and an answer to the equation printed on the back face of the flash card.

FIG. 7 is a front and back view of one example of a machine readable flash card used with this invention, with a mathematical equation on the front face of the flash card and a corresponding answer embedded in a machine readable device located on the back face of the flash card.

FIG. 8A is a front and back view of one example of antonym flash cards used with this invention.

FIG. 8B is a front and back view of one example of vocabulary flash cards used with this invention.

FIG. 8C is a front and back view of one example of language translation flash cards used with this invention.

FIG. 8D is a front and back view of one example of language usage flash cards used with this invention.

FIG. 8E is a front and back view of one example of specialized knowledge flash cards used with this invention.

FIG. 9A is a face view of four different sight word flash cards that are part of a group of sight word flash cards bundled together under a common theme for use with this invention.

FIG. 9B is a face view of four different math flash cards that are part of a group of math flash cards bundled together under a common theme for use with this invention.

FIG. 9C is a face view of four different general knowledge flash cards that are part of a group of general knowledge flash cards bundled together for use with this invention.

FIG. 9D is a face view of four different language translation flash cards that are part of a group of language translation flash cards bundled together under a common theme for use with this invention.

FIG. 10A shows a commonly known game die that may be used with this invention.

FIG. 10B shows a commonly known spinner board that may be used with this invention. (may need to add a FIG. 11 here for the game board drawing depicting the game board spaces) For purposes of clarity and brevity, like elements and components will bear the same designations and numbering throughout the Figures.

FIG. 11 shows an embodiment of the invention wherein a board is used for positioning the flash cards.

### DETAILED DESCRIPTION OF THE INVENTION

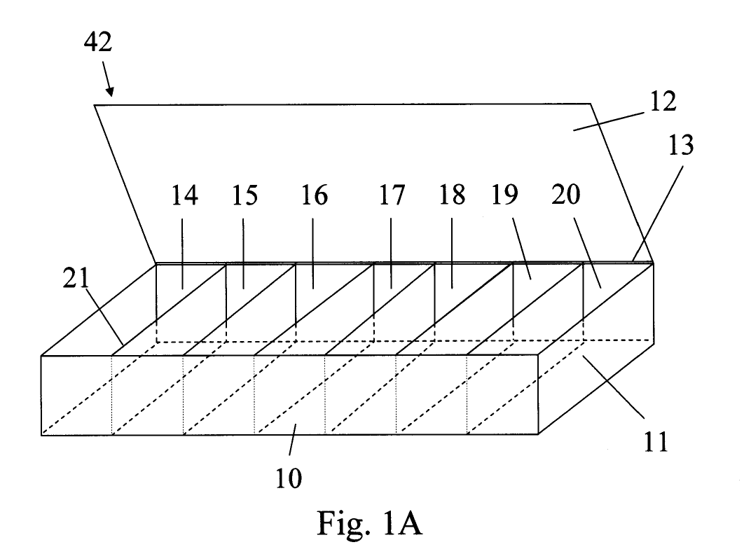

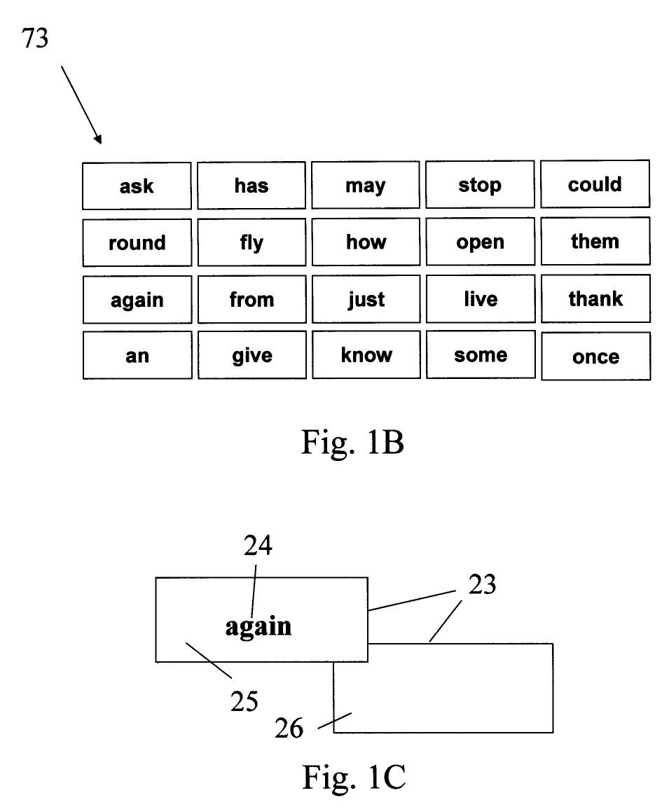

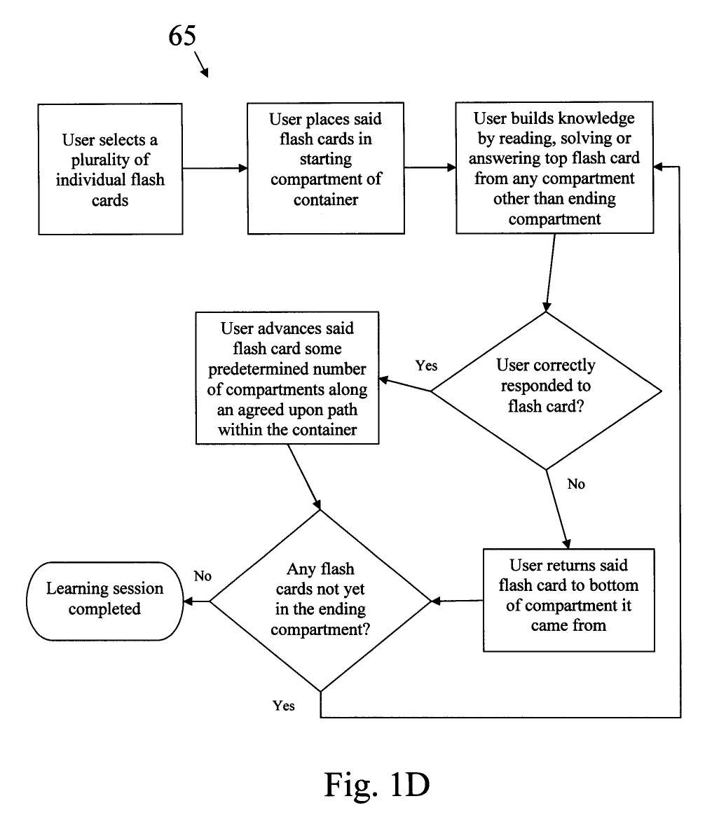

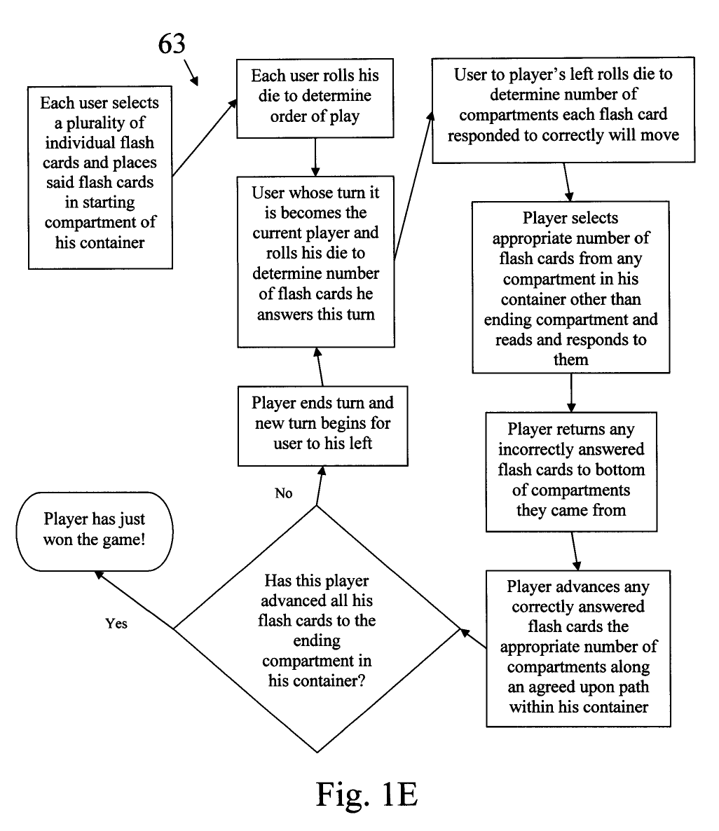

This section describes embodiments of the invention showing a learning system including game components and a method of using the game components that constitute an educational game that can be played by one or more players. The game components include a single-rowed container 42 and a plurality of individual flash cards 73, as illustrated in FIGS. 1A and 1B.

A preferred embodiment of container 42 is illustrated in FIG. 1A and contains seven compartments 14 through 20 that are preferably linearly aligned and are separated by interior compartment dividers 21. The compartments consist of a first compartment 14, a second compartment 15, a third compartment 16, a fourth compartment 17, a fifth compartment 18, a sixth compartment 19 and a seventh compartment 20. The size of container 42 may be approximately 3.5 cm in height, 28 cm in length and 6 cm in width. However, in other embodiments the container can have different sizes and relative dimensions and a varying number of compartments. A front of container 10 and a right side of container 11 are labeled to provide perspective. The cards may include any desired educational material of any desired difficulty levels.

In a preferred embodiment, the entirety of container 42 and all of the components are made of durable plastic but can be made in part or whole of alternative materials such as polyethylene, polypropylene, vinyl, nylon, rubber, leather, various impregnated or laminated fibrous materials, various plasticized materials, cardboard, paper, wood, metal, etc. or some combination of these. In the preferred embodiment, container 42 may be rectangular in shape and small and light weight enough to be easily transported to and from school and home.

Container 42 also has a hinged lid 12 that may be attached by a hinge 13. In the preferred embodiment hinge 13 may be formed from the same plastic material as hinged lid 12, container 42 and interior compartment dividers 21 and may be seamlessly connected to both the lid and the base of the container. However, hinge 13 can be made of any material that can be repeatedly bent without fracturing such as polyethylene, polypropylene, vinyl, nylon, rubber, leather, various impregnated or laminated fibrous materials, various plasticized materials, cardboard, paper, etc.

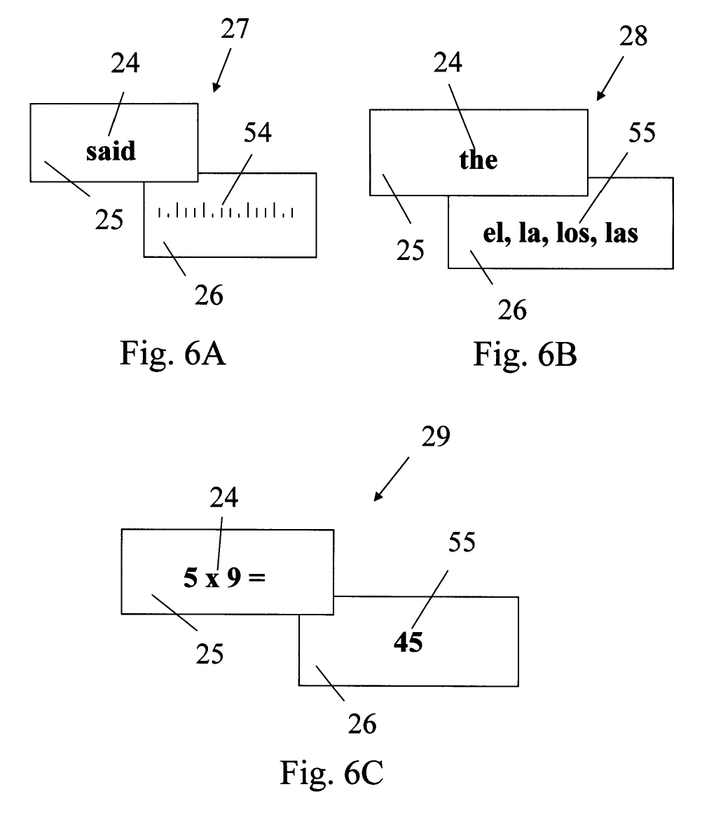

In one preferred embodiment, the game components include a plurality of individual flash cards 73. An individual flash card 23 has a front face 25 and a back face 26, as shown in FIG. 1C. The size of flash card 23 can be approximately 0.5 mm to 1 mm in thickness with an approximate length of 4 cm and width 1.5 cm. However, the flash card can have different sizes and relative dimensions. As illustrated in FIG. 1C, educational content 24 is contained on front face 25, while back face 26 is blank. Alternatively, as illustrated in FIG. 6A machine readable code 54 may be used on back face 26. In other embodiments, as illustrated in FIGS. 6B and 6C back face 26 could contain correlated educational content 55. FIG. 6A shows corresponding front and back faces of a sample sight word flash card 27 with machine readable code 54 on back face 26. FIG. 6B shows corresponding front and back faces of a sample language translation flash card 28. FIG. 6C shows corresponding front and back faces of a sample math flash card 29. In some embodiments neither face would contain educational content 24 so that a student, teacher or parent could personally customize flash card educational content 24 to a student's needs by manual illustration whenever necessary. In the preferred embodiment, educational content 24 may be an early elementary grade sight word, such as said, who, you, etc. However, educational content 24 can be any one or a combination of the following: a letter, a group of letters, a word, a group of words, a definition, a group of definitions, a sentence, a group of sentences, a number, a group of numbers, a mathematical equation, a group of mathematical equations, a picture, a group of pictures, a symbol, a group of symbols, a code, Braille, an image, a language, etc.

In some preferred embodiments, flash cards are made of 32 lb. paper. However, flash cards can be made of any material that can be made into thin, durable sheets and can retain a printed image on its front and back faces, such as cardboard, plastic, paper, varnished paper, various impregnated or laminated fibrous materials, various plasticized materials, etc. Alternatively, flash cards made of paper can be laminated on both sides with clear plastic lamination.

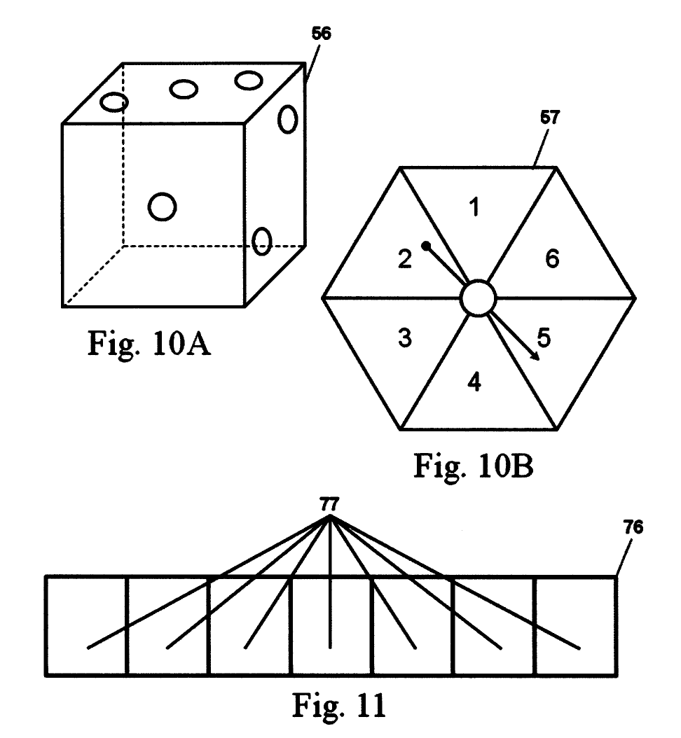

In a preferred embodiment, educational content 24 may be printed on card faces using standard black ink, however, educational content 24 can be printed using another color or combination of colors. In one alternative embodiment educational content 24 can be Braille. Alternatively, the game system can have a plurality of containers and use common six-sided die 56 as illustrated in FIG. 10A.

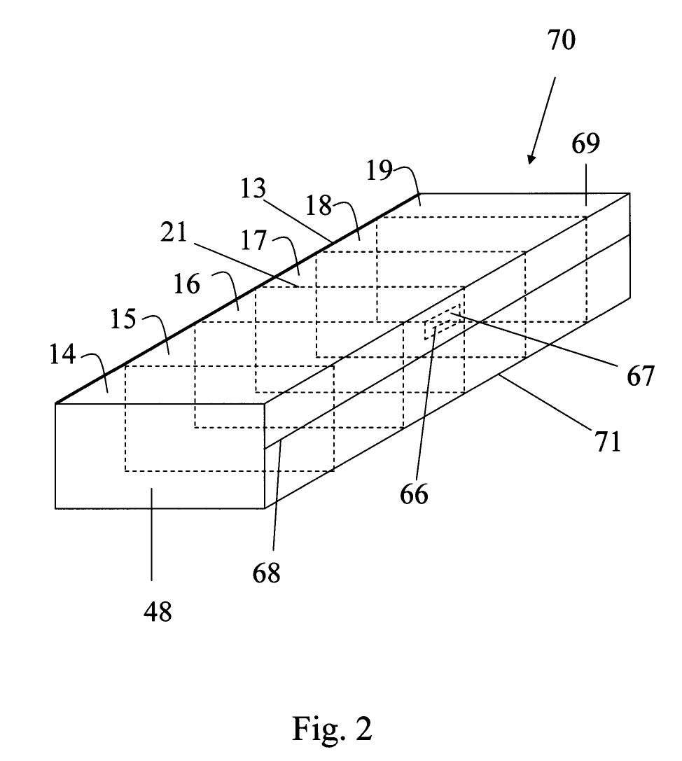

In a different embodiment, illustrated in FIG. 2, a container with a locking lid 70 uses a lock ridge 66 and a lock groove 67 to secure a locking lid 69. Locking lid 69 has a hinge 13 which connects it to the base of the container. Locking lid 69 also has an overlapping flap 68 which contains lock ridge 66 on its underside. Lock groove 67 may be located on the outside of front of container with locking lid 71. Lock ridge 66 may be positioned to fit within lock groove 67 when locking lid 69 is closed. Container with a locking lid 70 is divided into six compartments 14, 15, 16, 17, 18 and 19 that are separated by interior compartment dividers 21. A left side of container 48 is labeled to provide perspective.

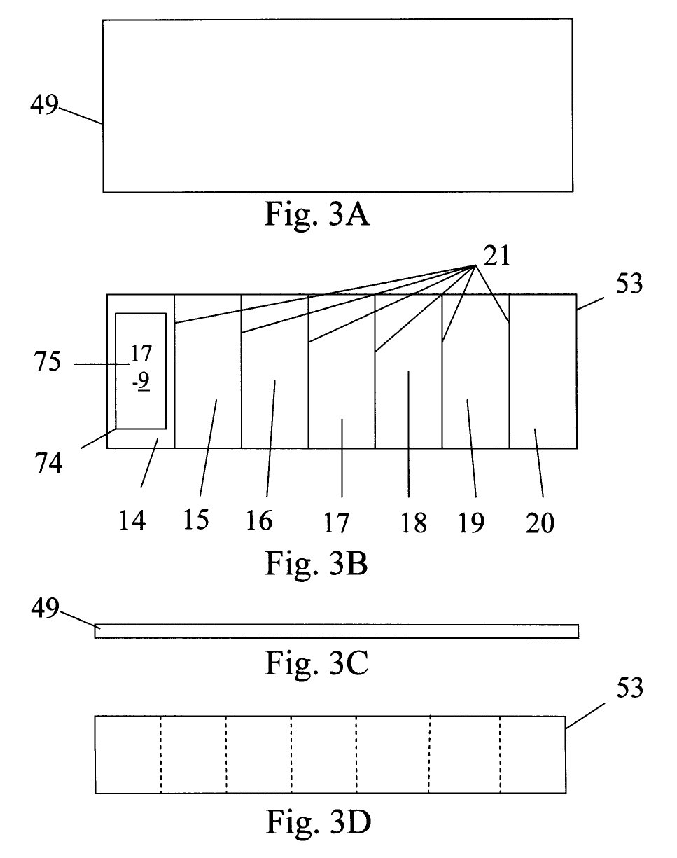

In an alternative embodiment, a container base 53 can be fully separated from its detached lid 49, as illustrated in FIGS. 3A, 3B, 3C and 3D. First example of a math flash card 74 and first example of educational content on a math flash card 75 are included in FIG. 3B to provide an example of how flash cards may be positioned within a compartment.

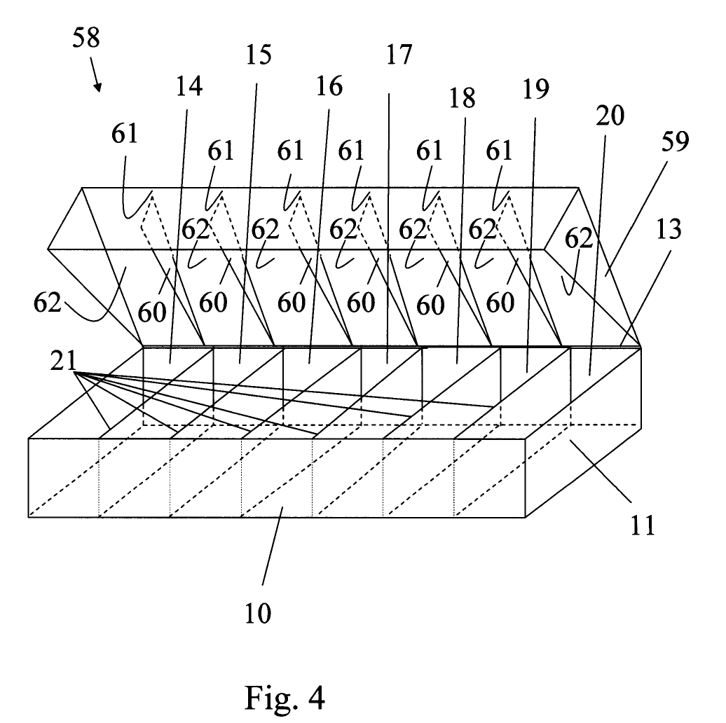

In another embodiment, a single-rowed container with lid dividers 58 has a divided lid 59 with a plurality of lid dividers 60 precisely positioned upon divided lid 59, as illustrated in FIG. 4. A front of container 10 and a right side of container 11 are labeled to provide perspective. When divided lid 59 is closed, each lid divider 60 is positioned just to the left of an interior compartment divider 21 when viewing container 58 from the front. The divided lid 59 is capable of being fully closed because of the positioning of the lid dividers and the existence of a lid closure gap 61 at the front end of each lid divider 60. Divided lid 59 closes over the front and sides of the bottom half of the container. Lid dividers 60 create a plurality of lid compartments 62 that are valuable in alternative methods of use for this learning system.

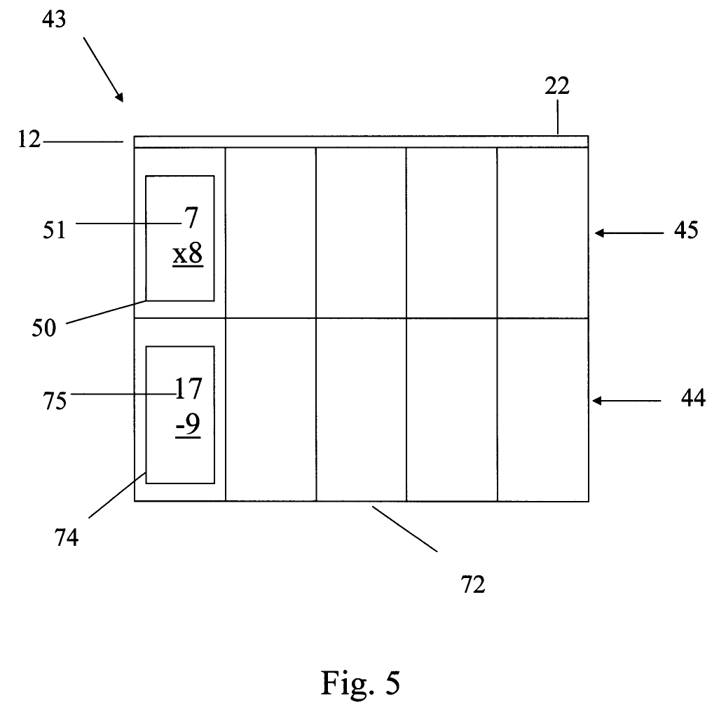

Alternatively, container 42 can have fewer or more compartments organized in rows, columns, circles, stacks, or some combination of these for the purpose of organizing and tracking the progression of flash cards as they are moved through the container while using the learning system. One such alternative embodiment may be a two-rowed container 43 illustrated in FIG. 5 which has a first row 44 and a second row 45 and also illustrates two examples of math flash cards 50 and 74 to show one way flash cards may be positioned within two-rowed container 43. A first example of a math flash card 74 contains a first example of educational content on a math flash card 75. A second example of a math flash card 50 contains a second example of educational content on a math flash card 51. A back of container 22 and a front of two-rowed container 72 and an opened hinged lid 12 are labeled for perspective.

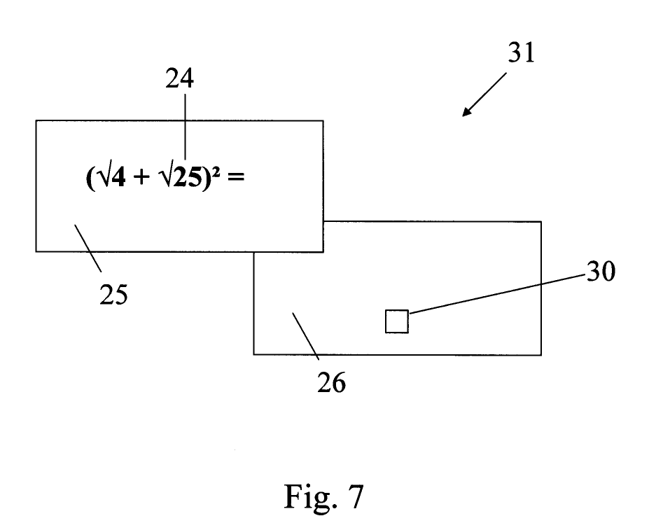

In an alternative embodiment, a machine readable flash card 31 may be affixed with a machine readable device 30 on back face 26 of the flash card, as illustrated in FIG. 7. Machine readable device 30 may be encoded with information corresponding to educational content 24 found on front face 25 of the flash card which makes it possible to electronically identify or read the flash card's educational content 24. Users of the learning system could study with a plurality of individual flash cards 73, each affixed with machine readable device 30. Machine readable device 30 could be an RFID chip, an electronic tag, a magnetic tag or some similar device that can be affixed to the back face 26 of flash card 31. Alternatively, machine readable device 30 can be embedded in flash card 31 or attached to or glued to either face of a flash card.

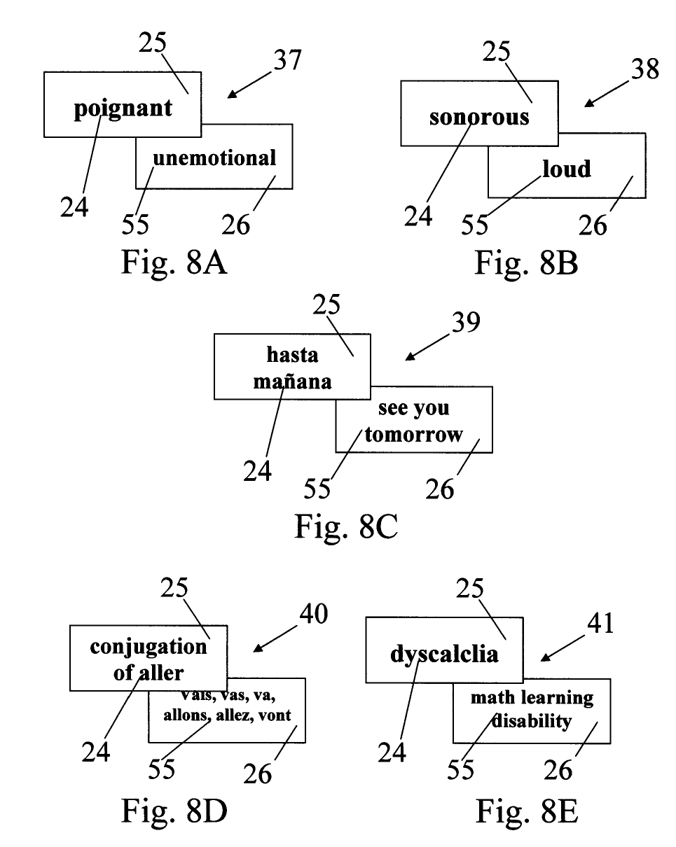

In another embodiment, educational content 24 on front face 25 of a flash card may be accompanied by a correlated educational content 55 on back face 26 of the flash card, as illustrated in FIGS. 6B and 6C. Examples of correlated educational content 55 may be found on, but not limited to, language translation, math equation and synonym flash cards. FIGS. 8A, 8B, 8C, 8D and 8E each illustrate an example of correlated educational content 55 on flash cards 37, 38, 39, 40 and 41. However, it is not necessary to always correlate content on back face 26 with content on front face 25. Examples of uncorrelated content which may be found on both sides of a flash card are, but not limited to, sight words, the alphabet, spelling words and phonetic sounds flash cards.

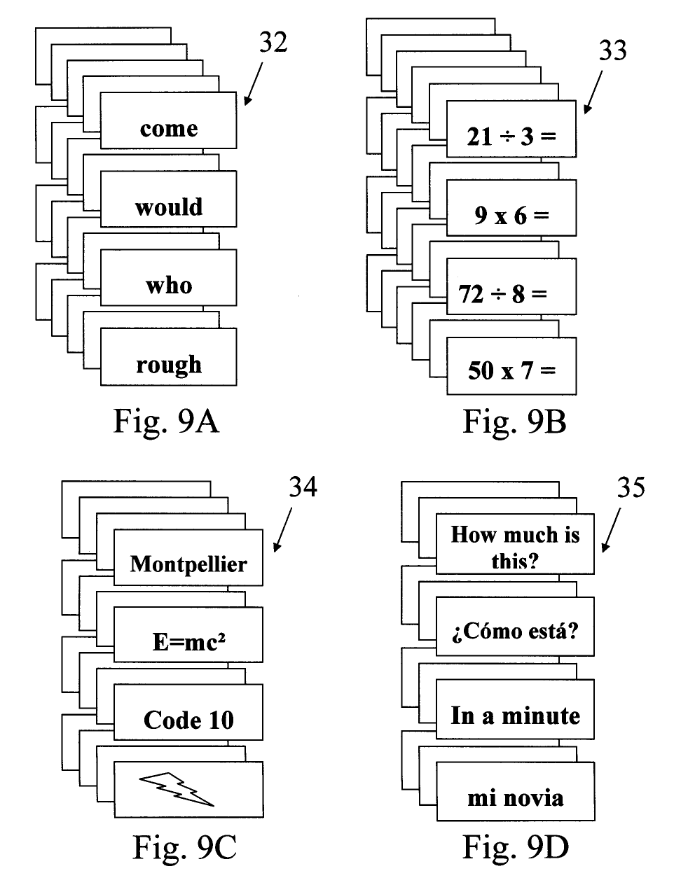

In an alternative embodiment, a plurality of individual flash cards 73 would be grouped into a number of bundles of individual flash cards 32, 33, 34 and 35, as illustrated in FIGS. 9A, 9B, 9C and 9D. These bundles would contain some number of flash cards that are grouped by theme, grade level, level of difficulty, or any other criteria or combination thereof that is useful to a user of this learning system. The number of flash cards in a bundle is not fixed and will vary from bundle to bundle. Some examples of bundles of flash cards are: Bundle of individual sight word flash cards 32 which in its illustration contains twenty flash cards; Bundle of individual math flash cards 33 which in its illustration contains twenty-four flash cards; and Bundle of individual language translation flash cards 35 which in its illustration contains twelve flash cards. Alternatively, a bundle of flash cards does not need to have a common theme and can simply be an eclectic grouping of cards such as Bundle of individual flash cards 34 which contains a group of sixteen general knowledge flash cards.

In the preferred embodiment, the game system has a container 42 and a plurality of individual flash cards 73 with educational content 24 on front face 25 of each flash card. Container 42 measures approximately 3.5 cm high by 6 cm wide by 28 cm long. The container has seven compartments 14, 15, 16, 17, 18, 19 and 20 positioned side by side such that individual compartment dimensions are approximately 3 cm high by 5.5 cm wide by 3.8 cm long. In alternative embodiments the size of the container and the number and size of the compartments can be larger or smaller.

An example of an alternative embodiment, could be a two-rowed container 43 consisting of two rows of five compartments for a total of 10 equally sized compartments within the two-rowed container. The two-rowed container's dimensions are approximately 3.5 cm high by 14 cm wide by 21 cm long. The equally sized compartment dimensions of two-rowed container 43 are approximately 3 cm high by 7 cm wide by 4 cm long. This alternative embodiment allows the game system to vary from the preferred embodiment in a way that remains consistent with the goal of providing a tool for systematic embedded repetitive study of knowledge, information and material. This alternative embodiment, like the preferred embodiment, promotes an important alternative use of the game system that may be well suited to people with a learning disability like dyslexia. With two-rowed container 43, a user can filter flash cards already mastered from flash cards that are yet to be mastered by designating one row for mastered flash cards and the other for flash cards yet to be mastered. An explanation of the method of use will be explained in more detail below. A single-rowed container with lid dividers 58 may be an alternative embodiment that accommodates the filtering of mastered flash cards from not yet mastered flash cards by providing lid compartments 62 as a place to put already mastered flash cards.

In one embodiment, container 42 would comprise a rectangular shaped box divided into seven equal size compartments and would have a single hinged lid 12 covering all of the compartments. In alternative embodiments, the container could have a non-rectangular shape divided into a plurality of compartments and could have one or more hinged lids or a detached lid.

In another alternative embodiment, the game components could contain a die 56 or an alternative mechanism, such as a spinner 57 as illustrated in FIG. 10B, an electronic number generator, etc., used to introduce the element of chance into the learning system. A player would roll die 56 once to determine the number of flash cards to be answered in a turn and then the same player or possibly a different one in the case of a multi-user game would roll die 56 again to determine the number of compartments or number of spaces 77 on game board 76 as illustrated in FIG. 11 that the correctly responded to flash cards will be advanced. Incorporating die 56 into the learning system may increase the benefit to kinesthetic learners who may need physical movement to enhance learning.

In the learning system preferred embodiment, an individual flash card 23 has educational content 24 on front face 25 of the flash card. In this illustration, educational content 24 is a word, however, depending upon the needs of the user, flash card 23 can have printed on one or both sides educational content 24 such as: a letter, a group of letters, a word, a group of words, a definition, a group of definitions, a sentence, a group of sentences, a number, a group of numbers, a mathematical equation, a group of mathematical equations, a picture, a group of pictures, a symbol, a group of symbols, a code, Braille, an image or some combination of these. In one alternative embodiment flash cards contain Braille instead of printed material. In another alternative embodiment flash cards may be blank on both sides. In still another alternative embodiment flash cards may display a barcode or contain other machine readable information such as information found on an RFID chip.

This section describes the educational learning system and method of use aspect of the invention that is designed to help people learn and master information and concepts. The system may be particularly useful for learning material that requires memorization. Examples of such material would be, but are not limited to, vocabulary pronunciations, definitions, word spelling and usage; the recognition and pronunciation of sight words, phonics, letters of the alphabet, and specialized medical and mathematics terminology. Other examples would include synonyms, antonyms and multiplication table memorization, as well as language usage for the English language and other languages. More examples of such material would be methods for conjugating verbs and solving simple and complex mathematical equations. The learning system may be designed to help both the general public, as well as, people with learning disabilities. For example, a person with dyslexia could use the learning system to learn and master sight word reading skills.

A person using the learning system learns and masters knowledge, information and material through embedded repetitive exposure to this knowledge, information and material in the course of independent use of the system as well as multi-person use of the system in the form of a competitive educational game. The objective of the learning system is to move a plurality of individual flash cards 73 containing information to be learned, as illustrated in FIG. 1B, through a series of compartments 14, 15, 16, 17, 18, 19 and 20 in a container 42, as illustrated in FIG. 1A. With the multi-user method of use the advancement of each user's flash cards may be determined by a combination of his correct responses and chance as determined by his roll of a common die 56 or spin of a common spinner 57 or use of some other instrument of chance such as but not limited to an electronic number generator. With single-user method of use 65 in FIG. 1D advancement of a user's flash cards does not require an instrument of chance.

There are a number of valuable features of the learning system that make it an effective learning tool. The learning system can be easily personalized to the needs, interests and skill level of a user by replacing, for example, a bundle of individual sight word flash cards 32 that no longer meet the needs of the user with a bundle of individual language translation flash cards 35 that does meet the user's needs. A bundle of individual flash cards 34 is simply a plurality of flash cards that may be color coded and come bundled by skill level, theme or a combination of skill level and theme. Bundles of individual flash cards can come packaged with the learning system and may be acquired separately as well.

Another valuable feature can be that the learning system systematically directs a learner's efforts towards material that has not yet been mastered and away from material that has already been mastered. However, the system's method of use may be highly adaptable and can be modified to even further focus learner's attention on material not yet mastered. As an example, an alternative method of use would be to remove a flash card from play whenever the flash card is responded to quickly and fluently, thus leaving in play only flash cards not yet responded to quickly and fluently. Alternatively, quickly and fluently responded to flash cards could be advanced extra compartments.

An added valuable feature of the game shows that a person can pause using the learning system for an unlimited time without losing track of the learning progress already made by the user. This is a feature referred to by the inventor as plausibility. Stopping or pausing the learning system is possible because of the unique combination of the design and use of the game system wherein a user's learning progress may be tracked by the location of flash cards within container 42 and the container can be closed to preserve the relative locations of the flash cards being being studied by the learner at that time. In the preferred embodiment, the player can move the flash cards from the game board into the corresponding container compartments. With the learning system a learner can begin a study session using the learning system, decide to pause the session, close container 42 and travel somewhere else and then continue the session exactly where the learner left off.

A further valuable feature of the learning system is that the container 42 and plurality of individual flash cards 73, can be highly portable which allows the game to be easily used independently or together with others in a competitive game while away from home, such as while on vacation or while visiting family over the holidays. This learning system can be so compact and portable that it can even be used on an airplane or in a car.

An additional valuable feature of the learning system may be that multiple users can participate in an engaging and evenly matched competitive educational game wherein each user selects a plurality of flash cards that is relevant to his or her needs and level of skill. For example in a competitive game with three players, one user could be improving his command of 1st grade sight words, while another user is mastering her 2nd grade adjectives, while a third user is practicing 1st grade words that are encountered with high frequency, or otherwise known in education circles as high frequency words. This game of three players, each playing with flash cards that are appropriately challenging to him or her, can be won by anyone including the least skilled user because each user is being challenged at his or her skill level.

In one preferred embodiment, the flash card learning material focuses on the needs and interests of elementary school age children and people of all ages with learning disabilities. Flash card learning material could include: high frequency words for first graders, states and state capitals, multiplication table equations for third graders, beginner English/Spanish vocabulary or sight words for anyone struggling to recall the proper pronunciation of these exceptional words. A learner would be able to select a plurality of individual flash cards 73 to use with the learning system that met his current learning needs, such as 1st grade sight words or 5th grade multiplication equations.

In an alternative embodiment, the focus of flash card learning material would expand to meet the needs of the general public as well as any specialized group of people that would benefit from this type of learning system, such as medical students for example. Similarly, a learner would be able to select a plurality of individual of flash cards to use with the learning system that met his current learning needs, such as advanced vocabulary or medical terminology for 1st year students in a medical doctor residency program.

The following paragraphs describe embodiments of the method of operation of the educational game. The method component of the learning system for single-user method of use 65, is illustrated in FIG. 1D and multi-user method of use 63, is illustrated in FIG. 1E. With the single-user method of use 65, a single person would strive to move a plurality of individual flash cards 73 through a predetermined series of compartments within container 42. Each flash card of plurality of individual flash cards 73 may be moved individually and only when read, solved, answered or responded to correctly.

Play begins with the user selecting plurality of individual flash cards 73. A plurality of individual flash cards 73 may contain any number of flash cards. Flash cards 73 could be a group or bundle of individual flash cards 34 with a common theme or level of difficulty as described several paragraphs above and illustrated in FIGS. 9A, 9B, 9C and 9D. However, flash cards 73 could be simply a random selection of flash cards as well. Examples of bundles that could be selected are: Bundle of Individual Sight Word Flash Cards 32; Bundle of Individual Math Flash Cards 33; Bundle of Individual Language Translation Flash Cards 35; and Bundle of Individual Flash Cards 34 which contains a plurality of general knowledge flash cards. A bundle of individual flash cards 34 may be a plurality of individual flash cards 73 with a common theme, skill level or theme and skill level. This list of bundles can be illustrative of the personalization and customization available to the user and the wide range of bundles with varying themes and skill levels that may be used with the learning system.

For the purpose of illustration let us imagine that a single user has selected a bundle of individual flash cards 34 containing 3rd grade sight words and has decided that he will move his flash cards one compartment at a time from a first or beginning position to an end position. For example in one embodiment, the user moves the flash cards through compartment 14 at the far left to seventh compartment 20 at the far right of container 42. The user then places bundle of individual flash cards 34 in first compartment 14 of container 42. The user then removes the top flash card in first compartment 14 to begin the learning session. On alternate embodiments, the start point may vary, the positions need not be in linear order, and the cards do not have to move only one direction.

In the case of this illustration, the proper response necessary to advance a sight word flash card would be to correctly read aloud the word on the flash card. If the user pronounces the word on the top flash card properly, then he places the top flash card one compartment to the right of the compartment from which the top flash card was selected. If he mispronounces the word on the top flash card, then he puts the top flash card at the bottom of the stack of flash cards in the compartment from which the top flash card was selected. The user then continues the learning session by drawing the next top flash card from first compartment 14 until all flash cards in first compartment 14 have been advanced to second compartment 15 or the user pauses using the learning system. When the user continues using the learning system he can apply the same method for advancing flash cards within container 42.

As game play progresses, the user may select flash cards one at a time from other compartments in container 42 as the advancing flash cards begin to populate these other compartments. The user continues to advance each correctly pronounced flash card to the compartment one to the right of the compartment from which the flash card was last drawn. An incorrectly pronounced flash card would be returned to the compartment from which it was last drawn. Alternatively, when the flash card is answered incorrectly, the flash card could be moved to another compartment, possibly closer to the start position. Play continues until the single user pauses again, concludes play by removing plurality of individual flash cards 73 from the container or completes the learning exercise by advancing all flash cards to the final compartment, which in the preferred embodiment of single-user method of use 65 is seventh compartment 20, located at the far right of container 42.

In an alternative illustration, using the learning system to master multiplication tables would be the same in all respects except that the user would be solving an equation, such as “2×6=”, instead of reading and pronouncing a word.

With multi-user method of use 63, two or more people, the players, would each strive to advance their selected plurality of individual flash cards 73 through a predetermined series of compartments within their container 42. Each flash card of plurality of individual flash cards 73 can be advanced individually and only when read, solved, answered or responded to correctly. Play begins with each player selecting a plurality of individual flash cards 73. Each player's plurality of individual flash cards 73 could be a group or bundle of individual of flash cards with a common theme or level of difficulty as described above in the single-user method of use 65 section and illustrated in FIGS. 9A, 9B, 9C and 9D, but could be simply a random selection of flash cards as well.

For the purpose of illustration, let us imagine that there are three players, all of whom are 2nd graders who are young readers with varied levels of skill. The flash cards available to them contain words known as high frequency words that are commonly found in elementary school reading anthologies. Each of the three players has a different level of reading competency and therefore each player selects a different bundle of individual flash cards 34, each bundle appropriate to his or her reading level. In this illustration, each player selects one bundle of individual flash cards 34 from a plurality of flash card bundles that were ordered with the learning system at the time of purchase. Player one is reading at grade level and therefore would choose a bundle of individual flash cards 34 containing 2nd grade high frequency words. Player two is reading below grade level and would select a bundle of individual flash cards 34 containing either Kindergarten or 1st grade high frequency words. Player three is reading above grade level and could select a bundle of individual flash cards 34 containing either 3rd, 4th or even 5th grade high frequency words, whichever is best matched to his or her skill level. In this illustration a bundle of individual flash cards 34 contains 15 cards. Alternatively, bundles used with the multi-user method of use can contain any number of flash cards desired by the users as long as each player has the same number of flash cards in his bundle.

Bundling flash cards into groups of flash cards is not a requirement of the learning system, but does help facilitate selecting flash cards, managing learner progress and tracking learner performance. As described earlier, pre-packaged bundles of flash cards can be incorporated into this learning system. Alternate bundles of flash cards need not be created but certainly can be if desired. This feature can be an important advantage and improvement of this invention over prior art such as bingo, traditional flash cards and many other games that provide little flexibility with the learning material incorporated into the game and insufficient means to manage learner progress and track learner performance.

Continuing this multi-user illustration, once flash card bundles are selected, each player places his or her bundle of individual flash cards 34 in first compartment 14 of his container 42. At this point, all players roll their respective die 56 simultaneously. The player who rolls the highest number is the one to begin play. For the purpose of illustration, let us call the player who rolls the highest number and begins the game, player one and the other players in this three-person game, player two and player three. In this illustration flash cards will be advanced linearly from first compartment 14 to seventh compartment 20 within container 42.

Player one begins her turn by rolling her die 56 to determine the number of individual flash cards that she will get a chance to answer during her turn. Let us image that she rolls a four. The player to her left, player two, then rolls his die 56 to determine the number of compartments each correctly answered flash card will advance during player one's turn. In this illustration, player two rolls a three, so player one may advance each correctly responded to flash card only three compartments this turn. In an alternative embodiment if player two rolls a number, in this illustration a four, that matches the number showing from player one's roll, then player one can choose to restart her turn and re-roll the die, if she wishes.

Player one now removes four flash cards from any compartment in the container. In this example, since this is player one's first turn of the game, she will be selecting the four flash cards from first compartment 14 of her container 42. If this were player one's fifth turn of the game, she could have flash cards in several compartments and could take the four flash cards from whichever compartment or compartments she wished. Player one would ideally take the four flash cards from compartments that took the most advantage of the three spaces she could advance correctly answered flash cards. Player one places each of the four flash cards selected outside of the container and right in front of the compartment from which it was drawn.

Once the four flash cards have been removed from the container, she can begin to answer each selected flash card, one at a time. If she answers a flash card correctly, then she advances the flash card the number of spaces allowed, which for this turn is three, as was determined by player two's recent roll of die 56. So for example, a flash card removed and placed in front of first compartment 14 would be advanced to fourth compartment 17 in this illustration. This can be calculated by adding the compartment number from which the flash card was drawn to the number from player two's die 56 roll to arrive at the compartment number the correctly answered flash card is advanced to: 1+3=4.

In one embodiment, if player one answers a flash card incorrectly, then she places the flash card back into the compartment from which it was removed (or in some embodiments the flash card is moved backwards to a compartment closer to the start position). After an attempt to answer the four flash cards has been made, player one's turn is over and the player to her left, player two, begins his turn by rolling his die 56 to determine the number of individual flash cards that he will get a chance to answer during his turn, while player three immediately thereafter rolls his die 56 to determine the number of compartments each correctly answered flash card will advance during player two's turn. Players continue taking turns by rotating play to the left until one player has advanced his or her entire bundle of individual flash cards 34 into seventh compartment 20, signifying the end of the game.

In an alternative method of use, a user would advance an individual flash card 23 some predetermined number of compartments greater than one, if the individual flash card 23 were answered swiftly and correctly. However, if the individual flash card 23 were answered correctly but not quickly or answered incorrectly, then the individual flash card 23 would be returned to the compartment from which it was drawn.

In another alternative method of use, a user would remove from play a flash card that is answered swiftly and correctly by either removing the flash card from container 42, or if using two-rowed container 43, then moving the flash card into the compartment above the compartment from which the flash card was drawn, or if using single-rowed container with divided lid 59, then moving the flash card into the lid compartment 62 above the compartment from which the flash card was drawn. In all three examples the flash card would be considered out of play, since it has already been mastered as indicated by the speed and fluency of the user's correct response. A flash card that is answered correctly but not quickly would advance only one compartment. A flash card that is answered incorrectly would be returned to the bottom of the compartment from which it was drawn.

The alternative methods of use described in each of these last two paragraphs are ways to increase the percentage of time spent learning material not yet mastered. This adaptability of the learning system is a major advantage and improvement of this invention over prior art such as bingo, traditional flash cards and many other games which have no systematic way to increase the percentage of time spent learning material not yet mastered by learners.

Another method for completing an independent learning session or confirming the winner of a multi-user game can be to require a user, once he has advanced his plurality of individual flash cards 73 to the final compartment, to correctly answer in rapid succession his plurality of individual flash cards 73 one last time. This alternative method would validate that material has been truly and completely mastered by the user.

A further example embodiment is seen in FIG. 11 wherein a board 76 is used for positioning flash cards on spaces 77 rather than the compartments of a container. The method of use is the same as that described previously for embodiments using a container, except that the flash cards are moved to spaces 76 on the board 77. This embodiment can also be picked up and the configuration or progress of the flash cards retained, if an associated container is used by simply moving the flash cards to container compartments corresponding to the spaces 77 on the board 76.

Although the description above contains much specificity regarding the learning system's method of use and alternative methods of use, this should not be construed as limiting the scope of the invention but as merely providing illustrations of some of the presently preferred embodiments of this invention. For example, the method of use can support many variations of the rules for moving correctly responded to flash cards to accommodate the needs of learners. Additionally, the method of use can adapt to changing embodiments of the learning system. Thus the scope of the invention should be determined by the appended claims and their legal equivalents, rather than by the examples given.

Since other modifications and changes varied to fit particular operating requirements and environments will be apparent to those skilled in the art, the invention is not considered limited to the example chosen for purposes of disclosure, and covers all changes and modifications which do not constitute departures from the true spirit and scope of this invention.

Having thus described the invention, what is desired to be protected by Letters Patent is presented in the subsequently appended claims.

1. An education method comprising the steps of:
selecting a set of flash cards;
providing a sequential series of positions having a start position and an end position;
positioning said flash cards on said start position in said sequential series of positions;
selecting at least one flash card from said set of flash cards;
solving at least one question posed on one of said at least one flash card;
placing said flash card on a sequential position closer to said end position, when a solution is correct;
placing said flash card, when a solution is incorrect, on a position selected from the group consisting of: a sequential position further from said end position, and a position from which said flash card was taken.

2. The method of claim 1, wherein the following steps are repeated:
selecting at least one flash card from said set of flash cards;
solving at least one question posed on one of said at least one flash card;
placing said flash card an a sequential position closer to said end position, when an solution is correct;
placing said flash card, when a solution is incorrect, on a position selected from the group consisting of: a sequential position further from said end position, and a position from which said flash card was taken.

3. The method of claim 1, wherein said selected set of flash cards have a selected educational content.

4. The method of claim 1, wherein said selected set of flash cards have a selected level of difficulty.

5. The method of claim 1, wherein said step of selecting at least one flash card further comprises the step of randomly determining a number of flash cards drawn.

6. The method of claim 1, wherein said step of placing said flash card on a sequential position closer to said end position further comprises the step of randomly determining a number of sequential positions closer to said end position on which said flash card will be placed.

7. The method of claim 1, wherein said sequential positions comprise at least one of member of the group consisting of: compartments in a container, and locations on a board.

8. The method of claim 7, wherein said container comprises at least one lid.

9. The method of claim 8, wherein positions of all said flash cards in said container comprise a current flash card configuration, and said method further comprises the step of saving said current flash card configuration by closing said at least one lid of said container.

10. The method of claim 7, wherein compartments in said container correspond to positions on said board, and wherein positions of all said flash cards on said board comprise a current flash card configuration, and said method further comprises the step of saving said current flash card configuration by moving flash cards from said positions on said board to said corresponding compartment in said container.

11. The method of claim 2, wherein said method may be performed sequentially by more than 1 user.

12. The method of claim 11, wherein each user possesses a separate selected set of flash cards and a separate series of sequential positions.

13. The method of claim 12, wherein a selected difficulty of each said selected set of flash cards is different for each user.

14. The method of claim 12, wherein a selected educational content of each said selected set of flash cards is different for each user.

15. The method of claim 11 wherein each said user competes to move all of the user's flash cards to said end position first.

16. An educational system comprising:
at least one set of flash cards,
a sequential series of positions having a first position and an end position, said container having at least one lid,
a means for generating a random number, and
instructions for using the educational system describing the following steps:
selecting a set of flash cards;
positioning said set of flash cards on said first position in said sequential series of positions;
selecting at least one flash card from said set of flash cards;
solving at least one question posed on one of said at least one flash card;
placing said flash card on a sequential position closer to said end position, when a solution is correct.
placing said flash card, when an answer is incorrect, on a position selected from the group consisting of: a sequential position closer to said first position, and a position from which said flash card was taken;

17. The educational system of claim 16 wherein said sequential series of positions comprises a container having at least one lid.

18. The educational system of claim 16 further comprising a game board including a sequential series of positions corresponding to said sequential series of positions of said container.

19. The educational system of claim 16 wherein said means for generating a random number comprises a die.
